(19) United States
(12) Patent Application Publication
(10) Pub. No.: US 2013/0215417 A1
(43) Pub. Date: Aug. 22, 2013

(54) SYSTEM AND METHOD FOR DETERMINING OPTICAL DISTRIBUTION NETWORK CONNECTIVITY

(71) Applicants: Jan Diestelmans, Geel (BE); Gerry Harvey, Newton, NC (US); Stije Meersman, Waasmunster (BE); Mario Simard, Sainta-Brigitte-de-Lava (CA); Joseph L. Simith, Fuquay Varina, NC (US); Daniel Garlepy, Quebec (CA); Marc Rondeau, Quebec (CA)

(72) Inventors: Jan Diestelmans, Geel (BE); Gerry Harvey, Newton, NC (US); Stije Meersman, Waasmunster (BE); Mario Simard, Sainta-Brigitte-de-Lava (CA); Joseph L. Simith, Fuquay Varina, NC (US); Daniel Garlepy, Quebec (CA); Marc Rondeau, Quebec (CA)

(21) Appl. No.: 13/588,145

(22) Filed: Aug. 17, 2012

Related U.S. Application Data
(60) Provisional application No. 61/525,556, filed on Aug. 19, 2011.

(51) Int. Cl. G01N 21/59

(52) U.S. Cl. CPC G01N 21/59
USPC 356/73.1

(57) ABSTRACT

A system and method for determining optical distribution network connectivity. In one embodiment, the system includes: (1) a transceiver configured to monitor at least one parameter and (2) a fiber bending device configured to introduce a bend into a particular fiber, the parameter exhibiting a corresponding attenuation when the bend is introduced and indicating a connectivity of the particular fiber.

### CROSS-REFERENCE TO RELATED APPLICATION

This Application claims the benefit of U.S. Provisional Application Serial No. 61/525,556 filed on Aug. 19, 2011, entitled “SYSTEM AND METHOD FOR DETERMINING OPTICAL DISTRIBUTION NETWORK CONNECTIVITY,” commonly assigned with the present invention and incorporated herein by reference.

### TECHNICAL FIELD

This application is directed, in general, to optical distribution networks (ODNs) and, more specifically, to a system and method for determining optical network connectivity.

### BACKGROUND

FTTx networks (“Fiber-to-the-x,” where “x” is a home, a business or any other endpoint) are being quickly and widely deployed to enable high-speed data distribution. (Endpoints may also be referred to as optical network terminations, or ONTs, or optical line terminations, or OLTs.) While electrical networks typically employ point-to-point interconnections among their intermediate nodes and endpoints, ODNs such as those FTTx networks include typically employ point-to-multipoint interconnections. Consequently, point-to-multipoint structures typically include many merging and splitting nodes (such as may be embodied in fiber distribution hubs, or FDHs), which multiply geometrically as endpoints increase linearly. Owing primarily to its point-to-multipoint structure, the ODN represents the most difficult part of FTTx management for the telecommunication operators that rely on them for income.

Accordingly, ODNs are deployed with an inventory management system that stores data concerning the ODN, including the interconnections among the merging and splitting nodes and the endpoints. The inventory management system is populated with data as the ODN is deployed and provisioned for customers. The data are retrieved and perhaps updated as the ODN is maintained over its lifetime.

### SUMMARY

One aspect provides a system for determining optical distribution network connectivity. In one embodiment, the system includes: (1) a transceiver configured to monitor at least one parameter and (2) a fiber bending device configured to introduce a bend into a particular fiber, the parameter exhibiting a corresponding attenuation when the bend is introduced and indicating a connectivity of the particular fiber.

Another aspect provides a method of determining optical distribution network connectivity. In one embodiment, the method includes: (1) monitoring at least one parameter of a transceiver, (2) introducing a bend into a particular fiber and (3) determining whether the at least one parameter exhibits a corresponding attenuation when the bend is introduced.

In another embodiment, the method includes: (1) monitoring at least one parameter of a transceiver, (2) introducing a bend into a particular fiber with a live fiber indicator, (3) determining whether the particular fiber is live and (4) further determining whether the at least one parameter exhibits a corresponding attenuation when the bend is introduced.

In yet another embodiment, the method includes: (1) introducing a bend into a particular fiber to be investigated for connectivity, (2) monitoring at least one transceiver parameter to detect attenuation resulting from the bend, (3) finding customers experiencing attenuation resulting from the bend and (4) assembling the customers into a list.

In still another embodiment, the method includes: (1) employing a live fiber indicator to introduce a bend into a particular fiber to be investigated for connectivity, (2) using the live fiber indicator to determine if traffic is present on the particular fiber, (3) if no traffic is present on the particular fiber, determining that no customers are connected to the particular fiber, (4) if traffic is present on the particular fiber, monitoring at least one transceiver parameter to detect any attenuation resulting from the bend, (5) finding customers experiencing attenuation resulting from the bend and (6) assembling the customers into a list.

In still yet another embodiment, the method includes: (1) employing an application executing on a computer, the application causing the computer to provide a user interface, (2) connecting a live fiber indicator to the computer, (3) causing the live fiber indicator to introduce a bend into a particular fiber to be investigated for connectivity, (4) detecting, with the computer, at least one attenuation resulting from the bend and (5) deriving the connectivity of the particular fiber from the at least one attenuation.

### BRIEF DESCRIPTION

Reference is now made to the following descriptions taken in conjunction with the accompanying drawings, in which:

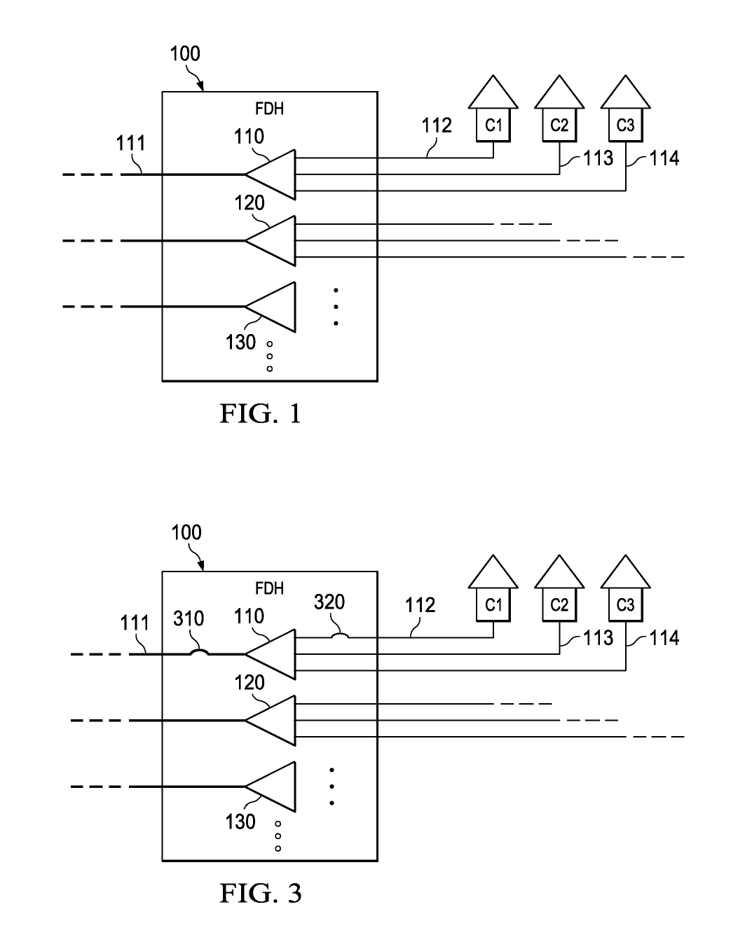

FIG. 1 is a block diagram of a portion of one embodiment of an ODN;

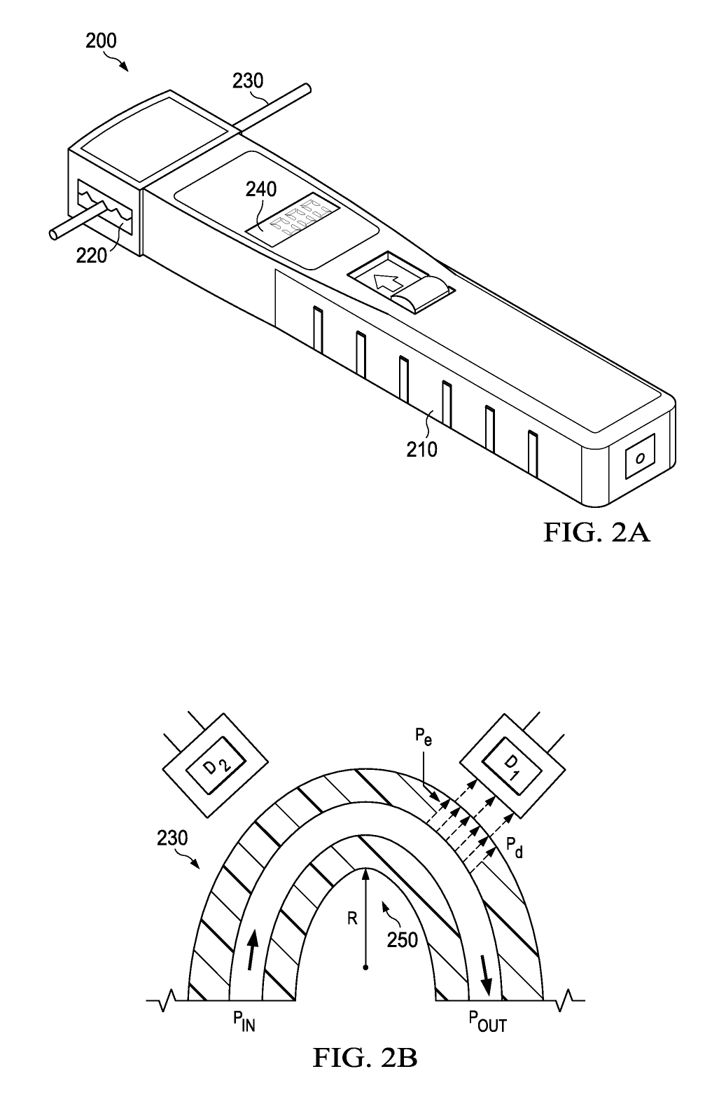

FIG. 2A is a schematic diagram of one embodiment of a fiber bending device, namely a live fiber identifier;

FIG. 2B is a schematic diagram of the fiber of FIG. 2A in which the fiber bending device has introduced a bend;

FIG. 3 is a block diagram of the portion of the ODN embodiment of FIG. 1 in which two bends are made in two fibers thereof;

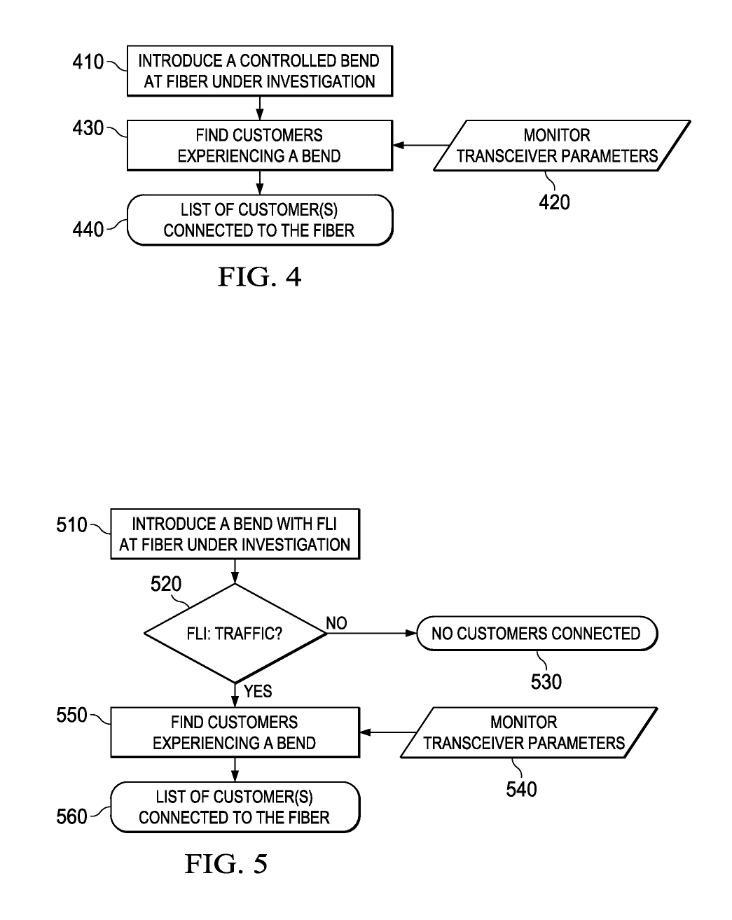

FIG. 4 is a flow diagram of one embodiment of a method of determining ODN connectivity;

FIG. 5 is a flow diagram of another embodiment of a method of determining ODN connectivity; and

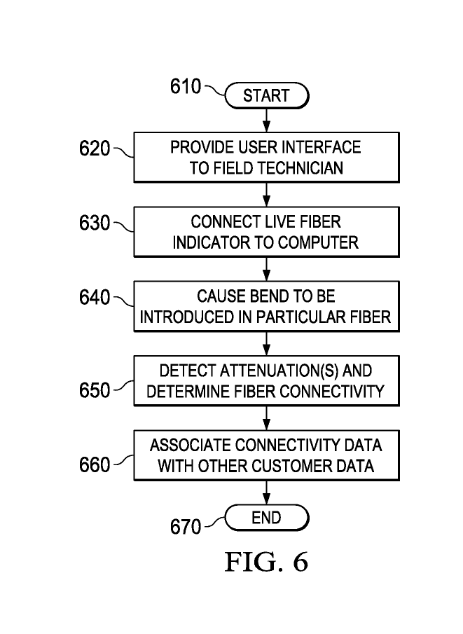

FIG. 6 is a flow diagram of yet another embodiment of a method of determining ODN connectivity.

### DETAILED DESCRIPTION

As described in the Background above, ODNs are deployed with an inventory management system that stores data concerning the ODN, including the interconnections among the merging and splitting nodes and the endpoints. The inventory management system is populated with data as the ODN is deployed and provisioned for customers. The data are retrieved and perhaps updated as the ODN is maintained over its lifetime.

Unfortunately, two significant problems have arisen. First, field technicians can misinterpret engineering drawings or other instructions during deployment of the ODN, resulting in erroneous inventory entries in the inventory management system. Second, field technicians may misunderstand the entries during service activation and maintenance of the ODN, protracting maintenance and inviting further erroneous inventory entries as updates are made to the inventory management system.

Consequently, telecommunication operators are searching for a more advanced inventory management system to overcome these problems. Some of these efforts have involved attempts to automate the process of populating and updating the data in the inventory management system thereby to avoid mistakes that can arise when data are managed manually. Telecommunication operators are particularly interested in finding a reliable way for a field technician to identify the customer or customers served by the fibers associated with a particular fiber distribution hub (FDH).

A so-called “intelligent ODN” (iODN) solution offered by the Huawei Technologies Co., Ltd. takes one approach to address this problem. With iODN, proprietary fiber connectors are fitted with a unique embedded identifier (eID) designed to cooperate with proprietary patch panels that are able to read the eID. The proprietary patch panels also have light-emitting diodes (LEDs) for each connection point that are powered by a Universal Serial Bus (USB) connection. With this particular infrastructure in place, a field technician can connect a handheld device to the proprietary patch panel through the USB connection, select a fiber from the inventory management system, and the corresponding LED will be activated as a visual indicator.

iODN has three problems. First, existing ODNs must be retrofitted with the proprietary connectors and patch panels. Second, new ODNs are constrained to use the proprietary connectors and patch panels. Third, the inventory management system still must be populated with accurate data correlating customers and eIDs during provisioning. Erroneous initial data entries result in ongoing maintenance issues.

FIG. 1 is a block diagram of a portion of one embodiment of an ODN and serves as an example environment within which a system and method for determining ODN connectivity may operate. An FDH 100 contains a plurality of splitters 110, 120, 130. A fiber 111 enters the splitter 110 on one side thereof, and three fibers 112, 113, 114 are connected at their upstream ends to the splitter 110 on the other side thereof. The fiber 112 leads to and is connected at a downstream end thereof to an ONT (not shown) associated with a customer C1. The fiber 113 leads to and is connected at a downstream end thereof to an ONT (not shown) associated with a customer C2. The fiber 114 leads to and is connected at a downstream end thereof to an ONT (not shown) associated with a customer C3. Each of the ONTs associated with the customers C1, C2, C3 has a transceiver associated therewith connected to an end of the respective fibers 112, 113, 114. Other unreferenced fibers lead to other unshown customers. The FDH 100 may contain further splitters as well.

Introduced herein are various embodiments of a system and method for determining ODN connectivity. The system and method do not rely on manual fiber-connectivity-tracing techniques. Nor do they require proprietary connectors or patch panels. Certain of the embodiments provide a novel solution to the problem of finding the customer or customers who are associated with a particular fiber (whose service would be affected were the fiber to be impaired, disconnected or otherwise interrupted).

The embodiments described herein call for monitoring at least one parameter (e.g., received signal power) of a transceiver, introducing a bend (which may have a known characteristic, such as an angle, radius, shape or attenuation factor) into a particular fiber, and determining whether the at least one parameter exhibits a corresponding attenuation when the bend is introduced. If the transceiver experiences the corresponding attenuation, the transceiver is associated with the particular fiber and therefore one that would be affected were the fiber to be impaired, disconnected or otherwise interrupted. By this process, the customers associated with the particular fiber can be determined.

Those skilled in the pertinent art know that conventional optical transceivers are configured to monitor and report various parameters, including the received signal power or amplitude, to control apparatus, such as an optical network controller. Such reporting may be done for the purpose of confirming that the ODN has been correctly deployed and provisioned and locating faults in the ODN as the ODN is operating. Those skilled in the art will recognize that such monitoring and reporting may also be used to detect and report attenuation resulting from an introduced bend as taught herein. Finally, those skilled in the art will understand that optical transceivers that have yet to be designed and other specialized optical receivers could be employed to monitor and report without departing from the scope of the invention.

In one embodiment, a fiber bending device introduces the bend into the particular fiber. In a related embodiment, the fiber bending device may be a hinged hand tool, essentially amounting to a specialized pair of pliers. In another embodiment, the fiber bending device may be a conventional live fiber detector (see, e.g., http://www.jdsu.com/en-us/Test-and-Measurement/Products/a-z-product-list/Pages/fi-60-live-fiber-identifier.aspx)

FIG. 2A is a schematic diagram of one embodiment of a fiber bending device, namely a live fiber identifier 200. In fact, FIG. 2A shows a conventional live fiber detector 200 that is commercially available from EXFO Inc. of Quebec City, Quebec, Canada (e.g., the LFD-300B Live Fiber Identifier). The live fiber detector 200 has a handle 210 configured to allow a field technician to hold the live fiber detector 200 as a hand tool and a clamp 220 configured to accept and compress a fiber 230 to introduce a bend (not shown in FIG. 2A) into the fiber 230.

As those in the pertinent art are aware, live fiber detectors are designed to allow field technicians to determine whether or not a particular fiber is “live” (carrying light) without having to disconnect it or having to guess. FIG. 2B is a schematic diagram of the fiber 230 of FIG. 2A in which the live fiber detector 200 has introduced a bend 250 of radius R. The bend 250 increases on average the angle at which any light P_{IN} that may be traveling in the fiber 230 impinges on the walls thereof, increasing the fraction of any light that impinges at an angle greater than the critical angle and thereby forcing some of any light P_{d} to exit the fiber 230. The live fiber detector 200 employs a light sensor D₁ to sense the presence or absence of the exiting light and indicates to the field technician whether or not the fiber is live based on the output of the sensor. Accordingly, the live fiber detector 200 includes a display 240 of FIG. 2A configured to provide such an indication to the field technician.

Those making this disclosure have recognized that the light P_{d} exiting the fiber 230 while bent is no longer able to travel in the fiber and therefore never reaches the transceiver at the receiving end of the fiber. Therefore, those making this disclosure have recognized that a conventional fiber bending device, which was designed solely to sense light P_{d} extracted from a fiber, could be put to a completely different, novel and nonobvious use, namely that of attenuating the light remaining in the fiber (represented in FIG. 2B by Pₑ and P_{OUT}). The resulting attenuation can then be detected in the transceiver at the receiving end of the fiber, allowing the routing of the fiber in a particular ODN, and ultimately the fibers to which customers are connected, to be determined. By performing this process once, or repeating it for other fibers, some or all of the connectivity of an ODN can be determined without having to trace the fibers by hand, which can be an extremely laborious and error-fraught process. Further, by introducing the bend proximate an upstream end of the fiber and employing the method described herein to identify where the downstream end of the fiber is connected, the connectivity of the fiber may be determined.

In the illustrated embodiment, the attenuation is detected by taking multiple light magnitude readings and relating at least two of them in some manner, e.g., by subtraction or division. In another embodiment, the attenuation is detected by taking at least one reading and relating it in some manner to a predetermined, expected magnitude, e.g., by subtraction or division. In either embodiment, the resulting difference(s), ratio(s) or results indicate the attenuation.

Having stated that a conventional fiber bending device may be a live fiber detector (e.g., the live fiber detector 200 of FIG. 2), it should be understood by those skilled in the pertinent art that any device, tool, mechanism or structure capable of introducing a bend in a fiber sufficient to produce a detectible signal attenuation in the fiber falls within the broad definition of “fiber bending device.” It should be noted that the fiber bending device needs no light sensors or displays; it can be an entirely passive device or perform additional, perhaps unrelated functions.

It is known in the art that optical fiber types having substantially different physical properties, such as refractive index profile within the fiber core and cladding, may impart correspondingly different levels of attenuation for a given applied bend parameter, such as bend angle, radius, bend shape, etc. It is further known that, for a particular fiber type, the level of bend-induced attenuation may differ significantly for different wavelengths (e.g. 1310 nm and 1550 nm). However, if the ODN is known a priori to be comprised of a uniform fiber type, and if the wavelength(s) propagating downstream to the monitoring transceiver (e.g. ONT) is (are) approximately known, any aforementioned “fiber bending device” may be employed, provided that the level of induced attenuation has been previously calibrated (or known “by design”) to a level that will not adversely affect the integrity of the optical signal transmission.

On the other hand, if the tests described in embodiments of the present invention are performed by a field technician who does not know with certainty either or both of the optical fiber type(s) and approximate propagation wavelength(s), there is a risk that customer signals may be inadvertently disrupted or, conversely, that the resulting bend-induced attenuation may be insufficient for reliable detection by the transceiver. This risk may be overcome by means of a live fiber identification device configured to employ the method specified in U.S. Pat. No. 7,710,552 by He. This prior-art method enables a degree of minimally-intrusive bend-induced attenuation (e.g. 0.7 dB) to be applied that is substantially independent of standard single-mode fiber type and signal wavelength.

Having described some embodiments of a system and a fiber bending device that may be employed to introduce a bend into a particular fiber, some experimental data concerning the attenuation that may result from the introduction of such a bend will now be presented.

TABLE 1
Signal Power Attenuation (Delta) Detected Before
Bending, While Bent and After Bending

| | ONT power (dBm) | | | | | | Delta | | |
|---|---|---|---|---|---|---|---|---|---|
| ADC-Leg 1 (No Attn) | 1 | 2 | 3 | 4 | 5 | Average | Avg | Min | Max |
| Before bending | −16.252 | −16.270 | −16.264 | −16.246 | −16.252 | −16.257 | −1.452 | 1.340 | 1.528 |
| While Bent | −17.610 | −17.726 | −17.720 | −17.712 | −17.774 | −17.708 | | | |
| After Bending | −16.280 | −16.252 | −16.236 | | | −16.256 | | | |
| ADC-Leg 2 (10 dB Attn) | 1 | 2 | 3 | 4 | 5 | Average | | | |
| Before Bending | −27.196 | −27.248 | −27.222 | | | −27.222 | −0.538 | 0.456 | 0.620 |
| While Bent | −27.704 | −27.732 | −27.760 | −27.788 | −27.816 | −27.760 | | | |
| Corning Gen 1 - Leg 5 | 1 | 2 | 3 | 4 | 5 | Average | | | |
| Before Bending | −27.904 | −27.992 | −27.932 | −28.022 | −28.022 | −27.974 | −0.716 | 0.634 | 0.856 |
| While Bent | −28.656 | −23.656 | −28.760 | | | −28.691 | | | |
| After Bending | −27.846 | −27.904 | | | | −27.875 | | | |
| Corning Gen 2 - Leg 20 | 1 | 2 | 3 | 4 | 5 | Average | | | |
| Before Bending | −27.046 | −27.146 | −27.070 | −27.096 | −27.146 | −27.101 | −1.938 | 1.682 | 2.375 |
| While Bent | −28.828 | −28.864 | −29.424 | | | −29.039 | | | |
| Corning Gen 3 - Leg 32 | 1 | 2 | 3 | 4 | 5 | Average | | | |
| Before Bending | −26.828 | −26.876 | −26.804 | | | −26.836 | −0.444 | 0.372 | 0.494 |
| While Bent | −27.274 | −27.298 | −27.298 | −27.248 | | −27.280 | | | |

Table 1 sets forth samples of signal power attenuation detected at a receiving transceiver for various commercially available fiber types (manufactured by ADC Telecom, now Tyco Connectivity, and Corning Incorporated) before bending, while bent and straightened after bending. In the specific experiment of Table 1, a nominal 0.5 dB of transceiver signal power attenuation is detected when the fiber is bent. It can therefore be seen that a controlled bend in each fiber type results in a measurable, predictable attenuation at the receiving transceiver.

FIG. 3 is a block diagram of the portion of the ODN embodiment of FIG. 1 in which two bends are made in two fibers thereof. As before, the FDH 100 contains the plurality of splitters 110, 120, 130. The fiber 111 enters the splitter 110 on one side thereof, and the three fibers 112, 113, 114 are connected at their upstream ends to the splitter 110 on the other side thereof. The fiber 112 leads to and is connected at a downstream end thereof to an ONT (not shown) associated with the customer C1. The fiber 113 leads to and is connected at a downstream end thereof to an ONT (not shown) associated with the customer C2. The fiber 114 leads to and is connected at a downstream end thereof to an ONT (not shown) associated with the customer C3. Also as before, each of the ONTs associated with the customers C1, C2, C3 has a transceiver associated therewith connected to an end of the respective fibers 112, 113, 114. Other unreferenced fibers lead to other unshown customers. The FDH 100 may contain further splitters as well.

A question may arise as to which of the customers C1, C2, C3 may be affected by a failure of the fiber 111. According to the teachings herein, a bend 310 may be introduced in the fiber 111. By monitoring the received signal power in each of the transceivers associated with the ONTs of the customers C1, C2, C3, a resulting attenuation will be detected in all three transceivers, leading to the conclusion that all three customers C1, C2, C3 would be affected were the fiber 111 to be impaired or fail.

A further question may arise as to which of the customers C1, C2, C3 may be affected by a failure of the fiber 112. According to the teachings herein, a bend 320 may be introduced in the fiber 112. Again, by monitoring the received signal power in each of the transceivers associated with the ONTs of the customers C1, C2, C3, a resulting attenuation will not be detected in the transceivers associated with the ONTs of customers C2 and C3, but will be detected in the transceiver associated with the ONT of customer 1, leading to the conclusion that only the customer C1 would be affected were the fiber 112 to be impaired or fail.

The connectivity of the fibers 111, 112 can thus be determined relative to the FDH 100 and the customers C1, C2, C3. By repeating the above-described process on other fibers associated with the FDH 100 and other FDHs and nodes of the ODN, the overall connectivity of the ODN can be determined or confirmed.

FIG. 4 is a flow diagram of one embodiment of a method of determining ODN connectivity. The method begins in a step 410 in which a bend is introduced into a particular fiber the connectivity of which is to be investigated. The bend may be a controlled bend resulting in a predictable attenuation. In a step 420, one or more transceiver parameters are monitored in an effort to detect any attenuation resulting from the bend. In a step 430, customers experiencing attenuation resulting from the bend are found. In a step 440, the affected customers are assembled into a list, which may then be entered into the inventory management system or otherwise processed as desired. For example, employed to connect a customer to another FDH or splitter.

The invention could also be used to execute an inventory audit/fill. The field technician in the FDH should then give the fiber location as an extra input to the algorithm. The output can then be compared with entries in the inventory are directly stored in the inventory when no entries are present yet, which can be done by the same software application that is described above.

A computer may be employed to provide the above-described information to the field technician by way, for example, of a display generated by a processing unit and then provided via a graphical interface to a display unit, such as a computer display or computer screen. Alternatively or additionally, the computer may provide the above-described information via a network interface to a further device, such as a network monitor (NM), an operations support system (OSS) or a business support system (BSS) located at, for example, a central office (CO). For this, the computer may contain a network interface. The list may be sent via a wireless network connection, such as a wireless local area network (W-LAN) or Universal Mobile Telecommunications System (UMTS), or a wirebound network connection, such as a LAN or an Internet connection, by the network interface.

The NM, OSS or BSS includes a network interface via which the NM, OSS or BSS receives the previously mentioned list from the field technician's computer. For transmitting the list (and perhaps other data such as attenuation levels), the computer may itself contain a network interface. The list (and perhaps other data) may be transmitted from the computer to the NM, OSS or BSS via a Simple Network Management Protocol (SNMP) or alternatively using a File Transfer Protocol (xFTP). In one embodiment, the NM sends a configuration file to the computer, defining what data shall be transmitted from the computer to the NM, OSS or BSS.

FIG. 5 is a flow diagram of another embodiment of a method of determining ODN connectivity. The embodiment employs a live fiber indicator to provide an initial indication of whether or not a particular fiber is even carrying light before further analyzing its connectivity. Accordingly, in a step 510, a live fiber indicator is employed to introduce a bend into a particular fiber the connectivity of which is to be investigated. As above, the bend may be a controlled bend resulting in a predictable attenuation. In a step 520, the live fiber indicator is used in its conventional role to determine whether or not the fiber is live (i.e., traffic is present on the fiber). If not, it is determined that no customers are connected to the fiber in a step 530. If the fiber is live, one or more transceiver parameters are monitored in a step 540 in an effort to detect any attenuation resulting from the bend. In a step 550, customers experiencing attenuation resulting from the bend are found. In a step 560, the affected customers are assembled into a list, which may then be entered into the inventory management system or otherwise processed as desired. As above, a computer may be employed to provide information to a field technician and/or an NM, OSS or BSS.

FIG. 6 is a flow diagram of yet another embodiment of a method of determining ODN connectivity. The embodiment of FIG. 6 is automated and includes an application executing on a computer (e.g., a general-purpose computer) configured to be employed on-site by a field technician. The method begins in a start step 610. In a step 620, the application causes the computer to provide a user interface to the field technician. The field technician can connect a live fiber indicator to the computer via a port (e.g., a Universal Serial Bus, or USB, port thereof) in a step 630. Once connected, the application causes the computer to cause the live fiber indicator to introduce a bend into a particular fiber in a step 640. In one embodiment, the computer does so directly. In an alternative embodiment, the computer prompts the field technician to do so manually. In a step 650, the application causes the computer to detect one or more attenuations resulting from the bend and derive the connectivity of the particular fiber therefrom. The application therefore may include an expert system capable of distinguishing attenuations caused by the bend from other attenuations. In a step 660, the application can cause the computer to associate the connectivity data with other customer data, e.g., identifying the customers and the service they are to receive. The method ends in an end step 670. Again, the computer may also be employed to provide information to an NM, OSS or BSS, perhaps as described above.

Those skilled in the art to which this application relates will appreciate that other and further additions, deletions, substitutions and modifications may be made to the described embodiments.

What is claimed is:

1. A method of determining optical distribution network connectivity, comprising:
monitoring at least one parameter of a transceiver;
introducing a bend into a particular fiber; and
determining whether said at least one parameter exhibits a corresponding attenuation when the bend is introduced.

2. The method as recited in claim 1 wherein said at least one parameter includes received signal power.

3. The method as recited in claim 1 wherein said bend has a known characteristic.

4. The method as recited in claim 1 wherein said known characteristic is selected from the group consisting of:
an angle,
a radius,
a shape, and
an attenuation factor.

5. The method as recited in claim 1 wherein said introducing is carried out proximate an upstream end of said fiber.

6. The method as recited in claim 1 further comprising repeating said monitoring, introducing and determining for other fibers in said optical distribution network.

7. The method as recited in claim 1, wherein the step of introducing a bend into a particular fiber is performed using a fiber bending device.

8. The method as recited in claim 7, wherein the bend being introduced by the fiber bending device has a known characteristic selected from the group consisting of an angle, a radius, a shape and an attenuation factor.

9. The method as recited in claim 1 wherein said fiber bending device is a live fiber indicator.

10. The method as recited in claim 9, wherein said live fiber indicator is operable to impart a predetermined level of attenuation in said particular fiber, said predetermined level being substantially independent of both type of said particular fiber and a signal wavelength.

11. A system for determining optical distribution network connectivity, comprising:
a transceiver configured to monitor at least one parameter; and
a fiber bending device configured to introduce a bend into a particular fiber, said parameter exhibiting a corresponding attenuation when the bend is introduced and indicating a connectivity of said particular fiber.

12. The system as recited in claim 11 wherein said at least one parameter includes received signal power.

13. The system as recited in claim 11 wherein said bend has a known characteristic.

14. The system as recited in claim 11 wherein said known characteristic is selected from the group consisting of:
an angle,
a radius,
a shape, and
an attenuation factor.

15. The system as recited in claim 11 wherein said bend is introduced proximate an upstream end of said fiber.

16. The system as recited in claim 11 wherein said fiber bending device is a live fiber indicator.

17. The system as recited in claim 16, wherein said bend imparts a predetermined level of attenuation in said particular fiber, said predetermined level being substantially independent of both type of said particular fiber and a signal wavelength.

18. A method for determining optical distribution network connectivity, comprising:
monitoring at least one parameter of a transceiver;
introducing a bend into a particular fiber with a live fiber indicator;
determining whether said particular fiber is live; and
further determining whether said at least one parameter exhibits a corresponding attenuation when the bend is introduced.

19. The method as recited in claim 18 wherein said at least one parameter includes received signal power.

20. The method as recited in claim 18 wherein said bend has a known characteristic.

21. The method as recited in claim 18 wherein said known characteristic is selected from the group consisting of:
an angle,
a radius,
a shape, and
an attenuation factor.

22. The method as recited in claim 18 wherein said introducing is carried out proximate an upstream end of said fiber.

23. The method as recited in claim 18 further comprising repeating said monitoring, introducing and determining for other fibers in said optical distribution network.

24. The method as recited in claim 18 further comprising associating connectivity data regarding said particular fiber with other customer data.

25. A method of determining optical distribution network connectivity, comprising:
introducing a bend into a particular fiber to be investigated for connectivity;
monitoring at least one transceiver parameter to detect attenuation resulting from said bend;
finding customers experiencing attenuation resulting from said bend; and
assembling said customers into a list.

26. The method as recited in claim 25 wherein said bend is a controlled bend resulting in a predictable attenuation.

27. The method as recited in claim 25 further comprising entering said list into an inventory management system.

28. The method as recited in claim 25 further comprising connecting at least one of said customers to another fiber distribution hub or splitter.

29. The method as recited in claim 25 further comprising employing said list to carry out at least one of:
filling an inventory,
updating an inventory, and
confirming an inventory.

30. A method of determining optical distribution network connectivity, comprising:
employing a live fiber indicator to introduce a bend into a particular fiber to be investigated for connectivity;
using said live fiber indicator to determine if traffic is present on said particular fiber;
if no traffic is present on said particular fiber, determining that no customers are connected to said particular fiber;
if traffic is present on said particular fiber, monitoring at least one transceiver parameter to detect any attenuation resulting from said bend;
finding customers experiencing attenuation resulting from said bend; and
assembling said customers into a list.

31. The method as recited in claim 30 wherein said bend is a controlled bend resulting in a predictable attenuation.

32. The method as recited in claim 30 further comprising entering said list into an inventory management system.

33. The method as recited in claim 30 further comprising connecting at least one of said customers to another fiber distribution hub or splitter.

34. The method as recited in claim 30 further comprising employing said list to carry out at least one of:
filling an inventory,
updating an inventory, and
confirming an inventory.

35. A method of determining optical distribution network connectivity, comprising:
employing an application executing on a computer, said application causing said computer to provide a user interface;
connecting a live fiber indicator to said computer;
causing said live fiber indicator to introduce a bend into a particular fiber to be investigated for connectivity;
detecting, with said computer, at least one attenuation resulting from said bend; and
deriving said connectivity of said particular fiber from said at least one attenuation.

36. The method as recited in claim 30 wherein said bend is a controlled bend resulting in a predictable attenuation.

37. The method as recited in claim 35 wherein said computer directly carries out said causing.

38. The method as recited in claim 35 wherein said computer provides a prompt to carry out said causing manually.

39. The method as recited in claim 35 wherein said application includes an expert system capable of distinguishing attenuations caused by said bend from other attenuations.

40. The method as recited in claim 35 further comprising associating said connectivity with other customer data.
